(19) United States
(12) Patent Application Publication
(10) Pub. No.: US 2024/0337504 A1
(43) Pub. Date: Oct. 10, 2024

(54) METHOD OF UPDATING HD MAP USING HETEROGENEOUS SENSOR MAP MATCHING, AND APPARATUS FOR PERFORMING SAME

(71) Applicant: HL Klemove Corp., Incheon (KR)

(72) Inventor: Yeongho SON, Suwon-si (KR)

(73) Assignee: HL Klemove Corp., Incheon (KR)

(21) Appl. No.: 18/239,914

(22) Filed: Aug. 30, 2023

(30) Foreign Application Priority Data
Apr. 10, 2023 (KR) 10-2023-0046610

(51) Int. Cl. G01C 21/00

(52) U.S. Cl. CPC G01C 21/3848; G01C 21/3822

(57) ABSTRACT

A method of updating an HD map using heterogeneous sensor map matching and an apparatus for performing the same according to an exemplary embodiment of the present disclosure determine whether or not the HD map has changed using map matching based on sensed values of heterogeneous sensors, and in a case where the HD map has changed, update the HD map based on the sensed values of the heterogeneous sensors, thereby reducing the cost and time required for maintenance of the HD map.

### CROSS-REFERENCE TO RELATED APPLICATION

This application claims the benefit of priority to Korean Patent Application No. 10-2023-0046610, filed on Apr. 10, 2023 in the Korean Intellectual Property Office, the entire content of which is incorporated herein by reference.

### TECHNICAL FIELD

The present disclosure relates to a method of updating a high definition (HD) map using heterogeneous sensor map matching and an apparatus for performing the same, and more particularly, to a method and apparatus for updating a HD map.

### BACKGROUND

For autonomous driving of Level 4 or higher, a positioning algorithm, a route generation algorithm, and a route planning algorithm using a high-definition (HD) map are essential. However, the shapes of roads on an HD map may differ from the shapes of actual roads due to road construction, changes in a feature (e.g., geographic features, terrain features, landmarks, etc.), and the like. Currently, it is necessary to collect and process data using expensive mobile mapping system (MMS) equipment. Accordingly, even partial repair of an HD map requires a lot of cost and time.

The information included in this Background of the present disclosure is only for enhancement of understanding of the general background of the present disclosure and may not be taken as an acknowledgement or any form of suggestion that this information forms the prior art already known to a person skilled in the art.

### SUMMARY

An object to be achieved by the present disclosure is to provide a method of updating an HD map using heterogeneous sensor map matching and an apparatus for performing the same for determining whether or not an HD map has changed using map matching based on sensed values of heterogeneous sensors and updating the HD map based on the sensed values of the heterogeneous sensors in a case where the HD map has changed.

Other objects that are not specified in the present disclosure may be additionally considered within the scope that can be easily inferred from the following detailed description and effects thereof.

A method of updating a high-definition (HD) map using heterogeneous sensor map matching according to an exemplary embodiment of the present disclosure to achieve the aforementioned object includes obtaining sensed values measured by heterogeneous sensors mounted in a vehicle, performing map matching using the HD map constructed in advance and the sensed values, and determining whether or not the HD map has changed based on a result of the map matching.

The performing of map matching may include performing the map matching on the HD map using the sensed values based on position values measured by a satellite-based positioning module mounted in the vehicle.

The performing of map matching may further include performing the map matching on the HD map using the sensed values based on the position values for each of the heterogeneous sensors.

The heterogeneous sensors may include a front view image sensor for obtaining a front view image of the vehicle, a surround view monitor (SVM) image sensor for obtaining a surround view image of the vehicle, and a Light Detection and Ranging (LiDAR) sensor for obtaining a point cloud of the vehicle using a laser.

The performing of map matching may further include matching the sensed values measured by the front view image sensor to the HD map based on the position values and performing lane matching by comparing a first lane obtained from the sensed values with a second lane obtained from the HD map.

The performing of map matching may further include matching the sensed values measured by the SVM image sensor to the HD map based on the position values and performing road marker matching by comparing a first road marker obtained from the sensed values with a second road marker obtained from the HD map.

The performing of map matching may further include matching the sensed values measured by the LiDAR sensor to the HD map based on the position values and performing feature matching by comparing a first point obtained from the sensed values with a second point obtained from the HD map.

The determining of whether or not the HD map has changed may include determining whether or not lanes on the HD map have changed based on a result of the lane matching, determining whether or not road markers on the HD map have changed based on a result of the road marker matching, and determining whether or not a feature on the HD map has changed based on a result of the feature matching.

The method may further include updating the HD map based on the sensed values in a case where the HD map has changed.

The updating of the HD map include updating the second lane on the HD map based on the first lane obtained from the sensed values measured by the front view image sensor in a case where the lanes on the HD map have changed, updating the second road marker on the HD map based on the first road marker obtained from the sensed values measured by the SVM image sensor in a case where the road markers on the HD map have changed, and updating the second point on the HD map corresponding to the feature based on the first point corresponding to the feature obtained from the sensed values measured by the LiDAR sensor in a case where the feature on the HD map has changed.

The obtaining of the sensed values, the map matching, the determining of whether or not the HD map has changed, and the updating of the HD map may be performed by an apparatus connected to at least one vehicle through a wireless communication network or performed by an electronic control unit (ECU) mounted in the vehicle.

An apparatus according to another exemplary embodiment of the present disclosure to achieve the aforementioned object includes a memory configured to store one or more programs for updating an HD map using heterogeneous sensor map matching, and at least one processor configured to perform operations for updating the HD map according to the one or more programs stored in the memory, wherein the at least one processor is configured to obtain sensed values measured by heterogeneous sensors mounted in a vehicle, perform map matching using the HD map constructed in advance and the sensed values, and determining whether or not the HD map has changed based on a result of the map matching.

The at least one processor may perform the map matching on the HD map using the sensed values based on position values measured by a satellite-based positioning module mounted in the vehicle.

The at least one processor may perform the map matching on the HD map using the sensed values based on the position values for each of the heterogeneous sensors.

The heterogeneous sensors may include a front view image sensor for obtaining a front view image of the vehicle, a SVM image sensor for obtaining a surround view image of the vehicle, and a LiDAR sensor for obtaining a point cloud of the vehicle using a laser.

The at least one processor may match the sensed values measured by the front view image sensor to the HD map based on the position values and perform lane matching by comparing a first lane obtained from the sensed values with a second lane obtained from the HD map.

The at least one processor may match the sensed values measured by the SVM image sensor to the HD map based on the position values and perform road marker matching by comparing a first road marker obtained from the sensed values with a second road marker obtained from the HD map.

The at least one processor may match the sensed values measured by the LiDAR sensor to the HD map based on the position values and perform feature matching by comparing a first point obtained from the sensed values with a second point obtained from the HD map.

The at least one processor may determine whether or not lanes on the HD map have changed based on a result of the lane matching, determine whether or not road markers on the HD map have changed based on a result of the road marker matching, and determine whether or not a feature on the HD map has changed based on a result of the feature matching.

The at least one processor may update the HD map based on the sensed values in a case where the HD map has changed.

A vehicle according to still another exemplary embodiment of the present disclosure to achieve the aforementioned object includes heterogeneous sensors measuring sensed values, at least one processor performing operations for updating a high-definition (HD) map, wherein the at least one processor is configured to: obtain sensed values measured by heterogeneous sensors mounted in a vehicle, perform map matching using the HD map constructed in advance and the sensed values, and determining whether or not the HD map has changed based on a result of the map matching.

According to the method of updating an HD map using heterogeneous sensor map matching and the apparatus for performing the same according to an exemplary embodiment of the present disclosure, it is possible to determine whether or not an HD map has changed using map matching based on sensed values of heterogeneous sensors and update the HD map based on the sensed values of the heterogeneous sensors in a case where the HD map has changed, thereby reducing cost and time required for maintenance of the HD map.

The effects of the present disclosure are not limited to the effects mentioned above, and other effects that are not mentioned will be clearly understood by those skilled in the art from the description below.

### BRIEF DESCRIPTION OF THE DRAWINGS

FIG. 1 is a block diagram for describing an apparatus according to an exemplary embodiment of the present disclosure.

FIG. 2 is a block diagram for describing a configuration of the apparatus shown in FIG. 1.

FIG. 3 is a flowchart for describing a method of updating an HD map using heterogeneous sensor map matching according to an exemplary embodiment of the present disclosure.

FIG. 4 is a diagram for describing a lane matching operation according to an exemplary embodiment of the present disclosure.

FIG. 5 is a diagram for describing an example of the lane matching operation shown in FIG. 4.

FIG. 6 is a diagram for describing a road marker matching operation according to an exemplary embodiment of the present disclosure.

FIG. 7 is a diagram for describing an example of the road marker matching operation shown in FIG. 6.

FIG. 8 is a diagram for describing an example of a feature matching operation according to an exemplary embodiment of the present disclosure.

FIG. 9 is a diagram for describing an example of an HD map update operation according to an exemplary embodiment of the present disclosure in a case where an HD map has not changed.

FIG. 10 is a diagram for describing an example of an HD map update operation according to an exemplary embodiment of the present disclosure in a case where a lane on an HD map has changed.

FIG. 11 is a diagram for describing an example of an HD map update operation according to an exemplary embodiment of the present disclosure in a case where a road marker on an HD map has changed.

FIG. 12 is a diagram for describing an example of an HD map update operation according to an exemplary embodiment of the present disclosure in a case where a feature on an HD map has changed.

### DETAILED DESCRIPTION

Embodiments of the present disclosure will be described in detail with reference to the attached drawings. Effects and features of the present disclosure and a method for achieving the same will become apparent with reference to the embodiments described below in detail in conjunction with the drawings. However, the present disclosure is not limited to the embodiments described below and may be implemented in various forms. Rather, these embodiments are provided such that this disclosure will be through and complete and will fully convey the scope to those skilled in the art. Thus, the scope of the present disclosure should be defined by the claims. The same elements are designated by the same reference numerals throughout the specification.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

In this specification, terms such as “first” and “second” are used to distinguish one component from another, and the scope of the present disclosure should not be limited by these terms. For example, a first component may be referred to as a second component, and similarly, the second component may also be referred to as a first component.

In this specification, identification signs (e.g., a, b, c, and the like) for respective steps are used for convenience of description, and identification signs do not describe the order of the steps, and the steps may be performed in a different order from the order specified unless a specific order is indicated the context. That is, the steps may be performed in the same order as specified, may be performed substantially simultaneously, or may be performed in the reverse order.

In this specification, expressions such as “has”, “can have”, “include” or “can include” indicate the presence of a corresponding feature (e.g., numerical value, function, operation, or component such as a part) and does not preclude the presence of additional features.

Hereinafter, a method of updating an HD map using heterogeneous sensor map matching and an apparatus for performing the same according to exemplary embodiments of the present disclosure will be described in detail with reference to the accompanying drawings.

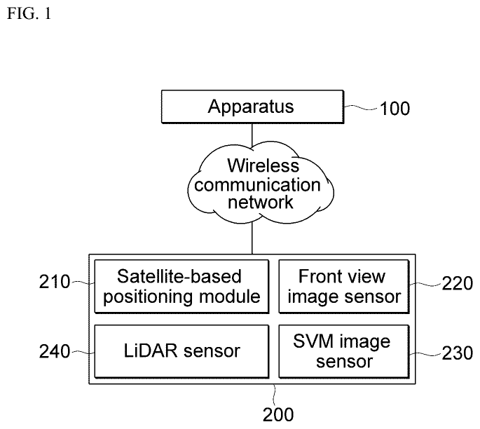

First, an apparatus according to an exemplary embodiment of the present disclosure will be described with reference to FIG. 1.

FIG. 1 is a block diagram for describing the apparatus according to an exemplary embodiment of the present disclosure.

Referring to FIG. 1, the apparatus 100 according to an exemplary embodiment of the present disclosure may update a pre-constructed high-definition map (HD map) using heterogeneous sensor map matching.

That is, the apparatus 100 may determine whether or not an HD map has changed using map matching based on sensed values of heterogeneous sensors provided from at least one vehicle 200 through a wireless communication network, and if the HD map has changed, update the HD map based on the sensed values of the heterogeneous sensors.

Accordingly, the apparatus 100 can reduce cost and time required for maintenance of the HD map.

In addition, the vehicle 200 may provide a position value measured by a satellite-based positioning module 210 mounted in the vehicle 200 and a sensed value measured by each of heterogeneous sensors mounted in the vehicle 200 to the apparatus 100 through the wireless communication network.

Here, the satellite-based positioning module 210 measures the current position of the vehicle by receiving radio signals from satellites and refers to a positioning module using a global navigation satellite system (GNSS) such as GPS, GLONASS, or GALILEO.

In addition, the heterogeneous sensors include a front view image sensor 220 that obtains a front view image of the vehicle 200, a surround view monitor (SVM) image sensor 230 that obtains a surround view image of the vehicle 200, and a Light Detection and Ranging (LiDAR) sensor 240 that obtains a point cloud of the vehicle 200 using a laser.

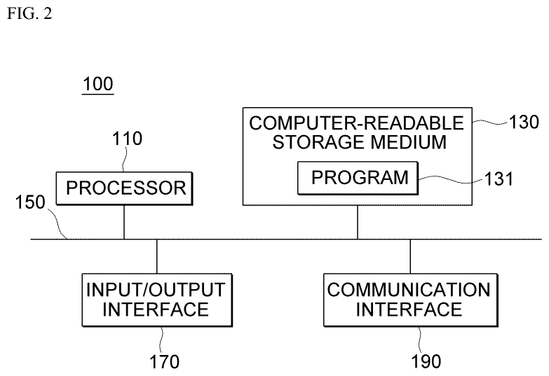

Next, the apparatus according to an exemplary embodiment of the present disclosure will be described in more detail with reference to FIG. 2.

FIG. 2 is a block diagram for describing a configuration of the apparatus shown in FIG. 1.

Referring to FIG. 2, the apparatus 100 may include one or more processors 110, a computer-readable storage medium 130, and a communication bus 150.

The processor 110 (e.g., computer, microprocessor, CPU, ASIC, circuitry, logic circuits, etc.) may control the apparatus 100 to operate. For example, the processor 110 may execute one or more programs 131 stored in the computer-readable storage medium 130. The one or more programs 131 may include one or more computer-executable instructions which may be configured to cause the processor 110 of the apparatus 100 to update an HD map using heterogeneous sensor map matching.

The computer-readable storage medium 130 is configured to store computer-executable instructions or program code, program data, and/or other suitable forms of information for updating an HD map using heterogeneous sensor map matching. The program 131 stored in the computer-readable storage medium 130 includes a set of instructions executable by the processor 110. In one embodiment, computer-readable storage medium 130 may be a memory (volatile memory such as a random access memory, a non-volatile memory, or a suitable combination thereof), one or more magnetic disk storage devices, optical disk storage devices, flash memory devices, other forms of storage media that can be accessed by the apparatus 100 and store desired information, or a suitable combination thereof.

The communication bus 150 interconnects various other components of the apparatus 100 including the processor 110 and the computer-readable storage medium 130.

The apparatus 100 may also include one or more input/output interfaces 170 that provide interfaces for one or more input/output devices and one or more communication interfaces 190. The input/output interface 170 and the communication interface 190 are connected to the communication bus 150. An input/output device (not shown) may be coupled to other components of the apparatus 100 via the input/output interface 170.

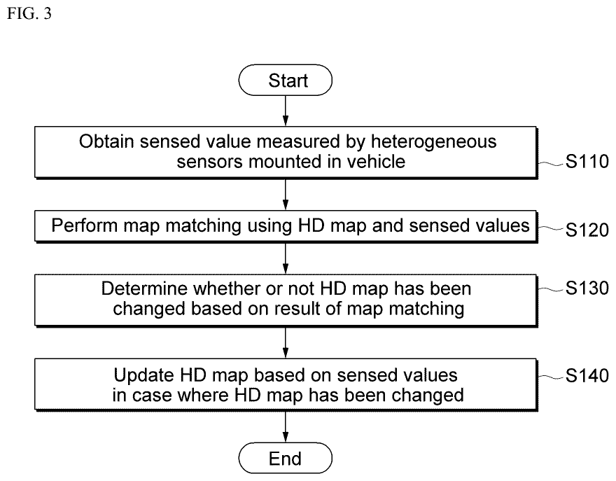

Next, a method of updating an HD map using heterogeneous sensor map matching according to an exemplary embodiment of the present disclosure will be described with reference to FIGS. 3 to 8.

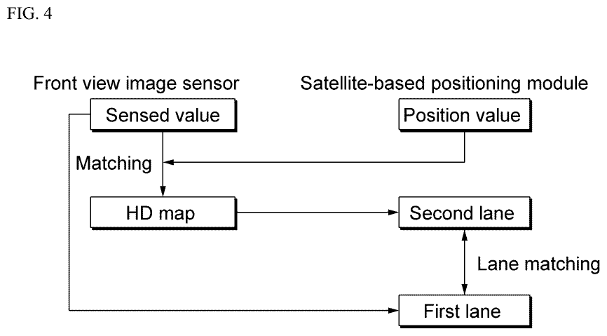

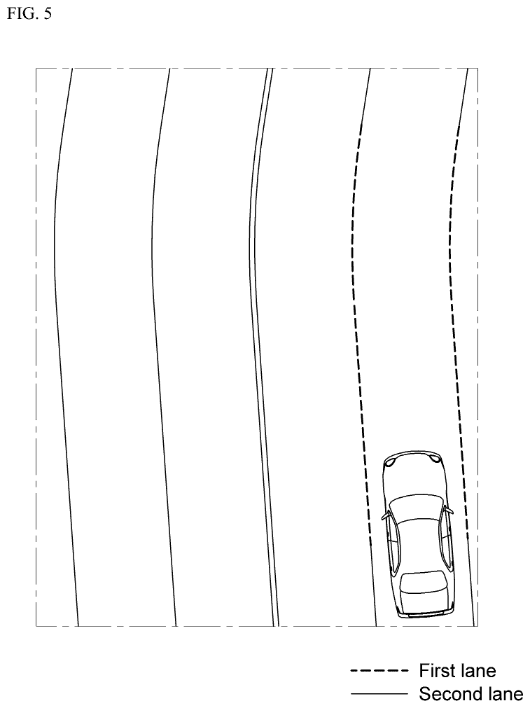

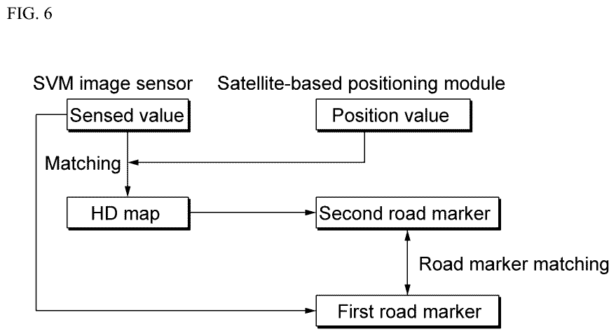

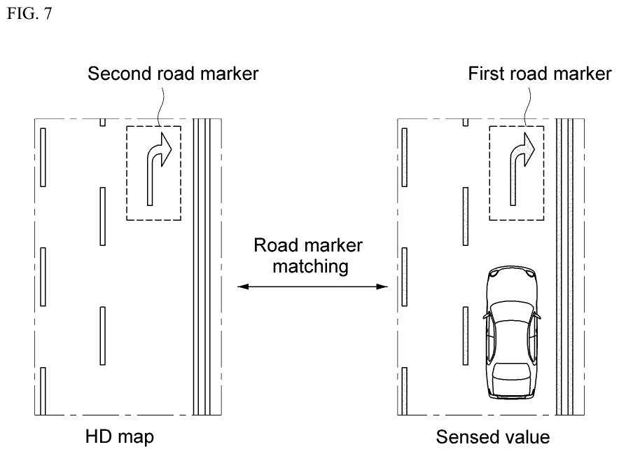

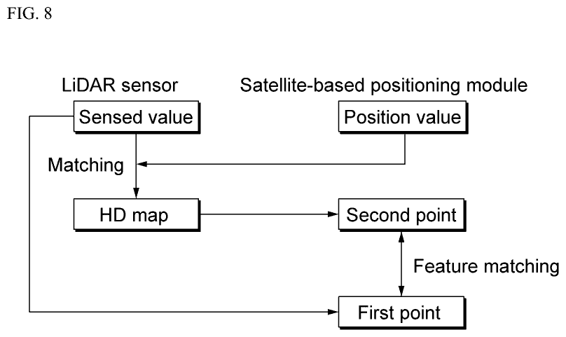

FIG. 3 is a flowchart for describing a method of updating an HD map using heterogeneous sensor map matching according to an exemplary embodiment of the present disclosure, FIG. 4 is a diagram for describing a lane matching operation according to an exemplary embodiment of the present disclosure, FIG. 5 is a diagram for describing an example of the lane matching operation shown in FIG. 4, FIG. 6 is a diagram for describing a road marker matching operation according to an exemplary embodiment of the present disclosure, FIG. 7 is a diagram for describing an example of the road marker matching operation shown in FIG. 6, and FIG. 8 is a diagram for describing an example of a feature matching operation according to an exemplary embodiment of the present disclosure.

Referring to FIG. 3, the processor 110 of the apparatus 100 may obtain sensed values measured by heterogeneous sensors mounted on the vehicle 200 (S110).

That is, the processor 110 may obtain position values measured by the satellite-based positioning module 210, sensed values measured by the front view image sensor 220, sensed values measured by the SVM sensor 230, and sensed values measured by the LiDAR sensor 240 from at least one vehicle 200 connected through a wireless communication network.

Then, the processor 110 may perform map matching using the HD map and the sensed values (S120).

That is, the processor 110 may perform map matching on the HD map using sensed values based on the position values.

In this case, the processor 110 may perform map matching on the HD map using sensed values based on the position values for each of the heterogeneous sensors.

More specifically, as shown in FIG. 4, the processor 110 may match the sensed values measured by the front view image sensor 220 to the HD map based on the position values, and perform lane matching by comparing a first lane obtained from the sensed values with a second lane obtained from the HD map.

Here, the first lane and the second lane may be represented by a third-order polynomial. In this case, the second lane may be obtained from the HD map using a spline interpolation method or the like.

For example, referring to FIG. 5, the processor 110 may match sensed values to the HD map using position values representing the location of the vehicle 200 and perform lane matching based on the first lane obtained from the sensed values and the second lane obtained from the HD map.

In addition, as shown in FIG. 6, the processor 110 may match the sensed values measured by the SVM image sensor 230 to the HD map based on the position values and perform road marker matching by comparing a first road marker obtained from the sensed values with a second road marker obtained from the HD map.

Here, road markers refer to markers indicated on the surface of a road and include lane direction guidance markers such as a “left turn lane guidance marker,” a “straight left turn lane guidance marker,” a “straight lane guidance marker,” a “straight right turn lane guidance marker,” and a “right turn lane guidance marker,” a crosswalk warning marker, and the like.

In addition, the first road marker may be obtained from sensed values using a deep learning-based road marker detection network previously trained and constructed. The road marker detection network may take an image as an input value and output a road marker (position and type of a road marker, and the like) as an output value. The road marker detection network may be constructed by being trained in advance using training data composed of images and correct-answer labels corresponding thereto (positions and types of road markers). That is, the processor 110 may input sensed values to the road marker detection network and obtain a road marker corresponding to the sensed values through output values of the road marker detection network.

For example, referring to FIG. 7, the processor 110 may match sensed values to the HD map using position values indicating the location of the vehicle 200 and perform road marker matching based on the first road marker obtained from the sensed values and the second road marker obtained from the HD map.

In addition, as shown in FIG. 8, the processor 110 may match the sensed values measured by the LiDAR sensor 240 to the HD map based on the position values and perform feature matching by comparing a first point obtained from the sensed values with a second point obtained from the HD map.

Here, features on an HD map may refer to a structure installed on a road, such as an overpass, a structure installed around a road, such as a building, and the like.

For example, the processor 110 may match sensed values to the HD map using position values representing the location of the vehicle 200 and perform feature matching based on the first point obtained from the sensed values and the second point obtained from the HD map. In this case, the processor 110 may perform feature matching using a map matching algorithm such as normal distributions transform (NDT) or iterative closest point (ICP).

Then, the processor 110 may determine whether or not the HD map has changed based on map matching results (S130).

That is, the processor 110 may determine whether or not lanes on the HD map have changed based on the result of lane matching.

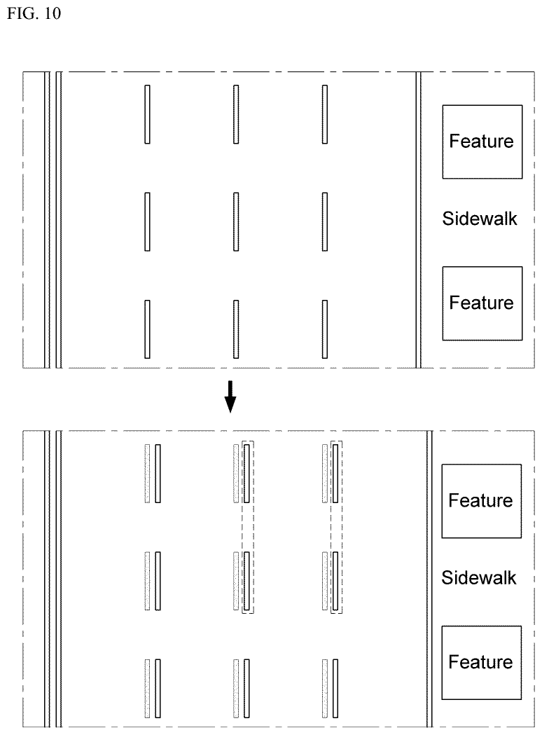

For example, if the difference between the first lane obtained from the sensed values of the front view image sensor 220 and the second lane obtained from the HD map exceeds a preset threshold value (FIG. 10), the processor 110 determines that the lanes on the HD map have changed. On the other hand, if the difference between the first lane and the second lane is within the preset threshold value, the processor 110 may determine that the lanes on the HD map have not changed.

In addition, the processor 110 may determine whether or not road markers on the HD map have changed based on the result of road marker matching.

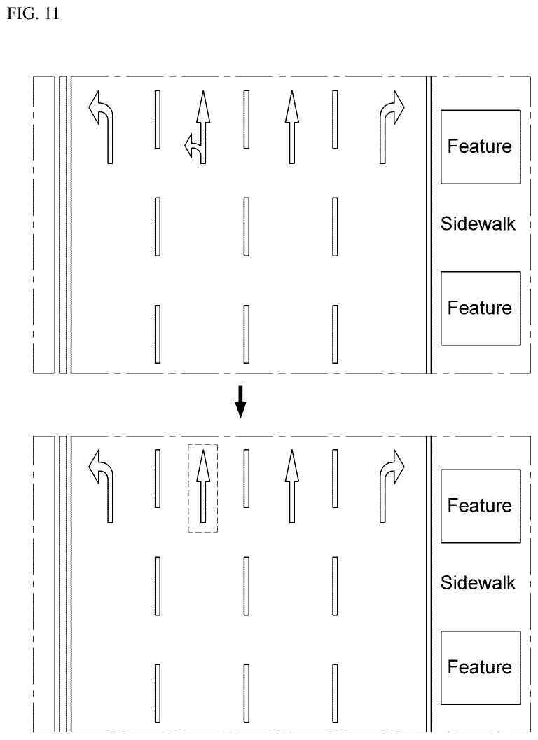

For example, as a result of matching the first road marker obtained from the sensed values of the SVM image sensor 230 with the second road marker obtained from the HD map, if the types of the road markers are different or the positions of the road markers deviate a preset threshold value (FIG. 11), the processor 110 may determine that the road markers on the HD map have changed. On the other hand, if the types of the road markers are the same and the positions of the road markers are within the preset threshold value, the processor 110 may determine that the road markers on the HD map have not changed.

In addition, the processor 110 may determine whether or not a feature on the HD map has changed based on a result of feature matching.

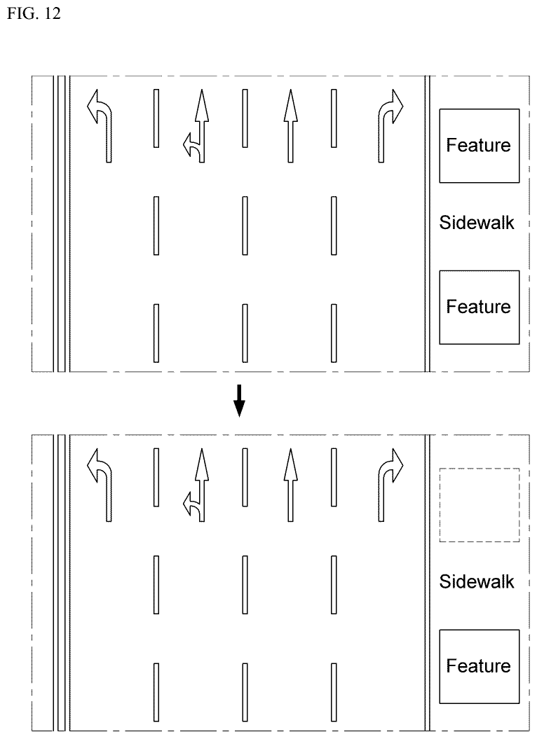

For example, as a result of matching the first point obtained from the sensed values of the LiDAR sensor 240 with the second point obtained from the HD map, if presence or absence of features, and/or features having different sizes and different locations are detected (FIG. 12), the processor 110 may determine that a feature on the HD map has changed. On the other hand, if presence or absence of features and features having different sizes and different locations are not detected, the processor 110 may determine that a feature on the HD map has not changed.

Then, in a case where the HD map has changed, the processor 110 may update the HD map based on sensed values (S140).

That is, when lanes on the HD map have changed, the processor 110 may update the second lane on the HD map based on the first lane obtained from the sensed values measured by the front view image sensor 220.

For example, if the difference between the first lane obtained from the sensed values of the front view image sensor 220 and the second lane obtained from the HD map exceeds a preset threshold value, the processor 110 may update the second lane on the HD map by performing a process of deleting the second lane from the HD map and adding the first lane to the HD map.

Further, in a case where road markers on the HD map have changed, the processor 110 may update the second road marker on the HD map based on the first road marker obtained from the sensed values measured by the SVM image sensor 230.

For example, as a result of matching the first road marker obtained from the sensed values of the SVM image sensor 230 with the second road marker obtained from the HD map, if the types of the road markers are different or the positions of the road markers deviate a preset threshold value, the processor 110 may update the second road marker on the HD map by performing a process of deleting the second road marker from the HD map and adding the first road marker to the HD map.

In a case where a feature on the HD map (e.g., a structure installed on a road, such as an overpass, a structure installed around a road, such as a building, or the like) has changed, the processor 110 may update the second point on the HD map corresponding to the feature based on the first point of the feature obtained from the sensed values measured by the LiDAR sensor 240.

For example, as a result of matching the first point obtained from the sensed values of the LiDAR 240 with the second point obtained from the HD map, if presence or absence of features and features having different sizes and different locations are detected, the processor 110 may update the second point on the HD may by performing a process of deleting the second point corresponding to the detected features from the HD map and adding the first point corresponding to the detected features to the HD map.

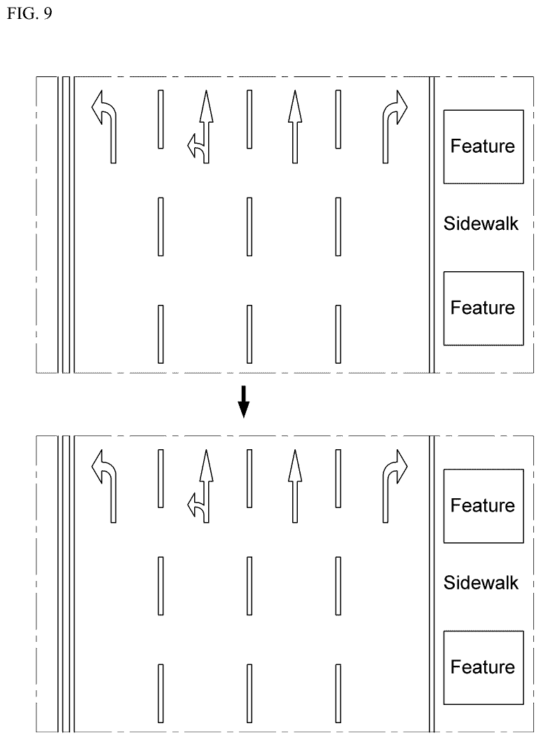

Next, an example of a method of updating an HD map using heterogeneous sensor map matching according to an exemplary embodiment of the present disclosure will be described with reference to FIGS. 9 to 12.

Case in which HD Map has not Changed

FIG. 9 is a diagram for describing an example of an HD map update operation according to an exemplary embodiment of the present disclosure in a case where an HD map has not changed.

Upon determining that lanes on the HD map have not changed as a result of lane matching, road markers on the HD map have not changed as a result of road marker matching, and features on the HD map have not changed as a result of feature matching, the processor 110 may maintain current information of the HD map as shown in FIG. 9.

Case in which Lanes on HD Map have Changed

FIG. 10 is a diagram for describing an example of an HD map update operation according to an exemplary embodiment of the present disclosure in a case where lanes on an HD map have changed.

Upon determining that lanes on the HD map have changed as a result of lane matching, the processor 110 may update the lanes on the HD map by deleting the second lane (grey lane) from the HD map and adding a new lane (white lane) to the HD map based on the first lane (dotted line box) as shown in FIG. 10.

Case in which Road Marker on HD Map has Changed

FIG. 11 is a diagram for describing an example of an HD map update operation according to an exemplary embodiment of the present disclosure in a case where a road marker on an HD map has changed.

Upon determining that a road marker on the HD map has changed as a result of road marker matching, the processor 110 may update road makers on the HD map by deleting a “straight left turn lane guidance marker” on the second lane, which is the second road marker, from the HD map and adding a new road marker, which is a “straight lane guide marker”, to the HD map based on the first road marker (dotted line box), as shown in FIG. 11.

Case in which Feature on HD Map has Changed

FIG. 12 is a diagram for describing an example of an HD map update operation according to an exemplary embodiment of the present disclosure in a case where a feature on an HD map has changed.

Upon determining that a feature on the HD map has changed as a result of feature matching, the processor 110 may update features on the HD map by deleting the second point corresponding to a detected feature from the HD map and adding a new point to the HD map based on the first point (dotted line box) corresponding to the detected feature, as shown in FIG. 12.

Although an example in which the method of updating an HD map using heterogeneous sensor map matching (sensed value acquisition step, map matching execution step, HD map change determination step, and HD map update step) according to the present disclosure is performed by the apparatus 100 connected to at least one vehicle 200 through a wireless communication network has been described, the method of updating an HD map using heterogeneous sensor map matching (sensed value acquisition step, map matching execution step, HD map change determination step, and HD map update step) according to the present disclosure may be performed by an electronic control unit (ECU) mounted in the vehicle 200.

Operations according to the present embodiments may be implemented in the form of program instructions that can be executed through various computer means and recorded in a computer-readable storage medium. The computer-readable storage medium refers to any medium that participates in providing instructions to a processor for execution. The computer-readable storage medium may include program instructions, data files, data structures, or combinations thereof. For example, the computer-readable storage medium may include a magnetic medium, an optical recording medium, a memory, and the like. A computer program may be distributed over computer systems connected via a network such that computer-readable code is stored and executed in a distributed manner. Functional programs, code, and code segments for implementing the present embodiment may be easily inferred by programmers in the art to which the present embodiment belongs.

The embodiments are for explaining the technical idea of the embodiments, and the scope of the technical idea of the present embodiment is not limited by these embodiments. The scope of protection of the present embodiment should be construed according to the claims below, and all technical ideas within the scope equivalent thereto should be construed as being included in the scope of rights of the present embodiment.

What is claimed is:

1. A method of updating a high-definition (HD) map using heterogeneous sensor map matching, comprising:
obtaining sensed values measured by heterogeneous sensors mounted in a vehicle;
performing map matching using the HD map constructed in advance and the sensed values; and
determining whether or not the HD map has changed based on a result of the map matching.

2. The method of claim 1, wherein the performing of map matching comprises performing the map matching on the HD map using the sensed values based on position values measured by a satellite-based positioning module mounted in the vehicle.

3. The method of claim 2, wherein the performing of map matching further comprises performing the map matching on the HD map using the sensed values based on the position values for each of the heterogeneous sensors.

4. The method of claim 3, wherein the heterogeneous sensors include a front view image sensor for obtaining a front view image of the vehicle, a surround view monitor (SVM) image sensor for obtaining a surround view image of the vehicle, and a Light Detection and Ranging (LiDAR) sensor for obtaining a point cloud of the vehicle using a laser.

5. The method of claim 4, wherein the performing of map matching further comprises matching the sensed values measured by the front view image sensor to the HD map based on the position values and performing lane matching by comparing a first lane obtained from the sensed values with a second lane obtained from the HD map.

6. The method of claim 5, wherein the performing of map matching further comprises matching the sensed values measured by the SVM image sensor to the HD map based on the position values and performing road marker matching by comparing a first road marker obtained from the sensed values with a second road marker obtained from the HD map.

7. The method of claim 6, wherein the performing of map matching further comprises matching the sensed values measured by the LiDAR sensor to the HD map based on the position values and performing feature matching by comparing a first point obtained from the sensed values with a second point obtained from the HD map.

8. The method of claim 7, wherein the determining of whether or not the HD map has changed comprises determining whether or not lanes on the HD map have changed based on a result of the lane matching, determining whether or not road markers on the HD map have changed based on a result of the road marker matching, and determining whether or not a feature on the HD map has changed based on a result of the feature matching.

9. The method of claim 8, further comprising updating the HD map based on the sensed values in a case where the HD map has changed.

10. The method of claim 9, wherein the updating of the HD map comprises:
updating the second lane on the HD map based on the first lane obtained from the sensed values measured by the front view image sensor in a case where the lanes on the HD map have changed;
updating the second road marker on the HD map based on the first road marker obtained from the sensed values measured by the SVM image sensor in a case where the road markers on the HD map have changed; and
updating the second point on the HD map corresponding to the feature based on the first point corresponding to the feature obtained from the sensed values measured by the LiDAR sensor in a case where the feature on the HD map has changed.

11. The method of claim 10, wherein the obtaining of the sensed values, the map matching, the determining of whether or not the HD map has changed, and the updating of the HD map are performed by an apparatus connected to at least one vehicle through a wireless communication network or performed by an electronic control unit (ECU) mounted in the vehicle.

12. An apparatus comprising:
a memory configured to store one or more programs for updating a high-definition (HD) map using heterogeneous sensor map matching; and
at least one processor configured to perform operations for updating the HD map according to the one or more programs stored in the memory,
wherein the at least one processor is configured to:
obtain sensed values measured by heterogeneous sensors mounted in a vehicle;
perform map matching using the HD map constructed in advance and the sensed values; and
determining whether or not the HD map has changed based on a result of the map matching.

13. The apparatus of claim 12, wherein the at least one processor performs the map matching on the HD map using the sensed values based on position values measured by a satellite-based positioning module mounted in the vehicle.

14. The apparatus of claim 13, wherein the at least one processor performs the map matching on the HD map using the sensed values based on the position values for each of the heterogeneous sensors.

15. The apparatus of claim 14, wherein the heterogeneous sensors include a front view image sensor for obtaining a front view image of the vehicle, a surround view monitor (SVM) image sensor for obtaining a surround view image of the vehicle, and a Light Detection and Ranging (LiDAR) sensor for obtaining a point cloud of the vehicle using a laser.

16. The apparatus of claim 15, wherein the at least one processor matches the sensed values measured by the front view image sensor to the HD map based on the position values and performs lane matching by comparing a first lane obtained from the sensed values with a second lane obtained from the HD map.

17. The apparatus of claim 16, wherein the at least one processor matches the sensed values measured by the SVM image sensor to the HD map based on the position values and performs road marker matching by comparing a first road marker obtained from the sensed values with a second road marker obtained from the HD map.

18. The apparatus of claim 17, wherein the at least one processor matches the sensed values measured by the LiDAR sensor to the HD map based on the position values and performs feature matching by comparing a first point obtained from the sensed values with a second point obtained from the HD map.

19. The apparatus of claim 18, wherein the at least one processor determines whether or not lanes on the HD map have changed based on a result of the lane matching, determines whether or not road markers on the HD map have changed based on a result of the road marker matching, and determines whether or not a feature on the HD map has changed based on a result of the feature matching.

20. The apparatus of claim 19, the at least one processor is further configured to update the HD map based on the sensed values in a case where the HD map has changed.

21. A vehicle comprising:
heterogeneous sensors measuring sensed values;
at least one processor performing operations for updating a high-definition (HD) map, the at least one processor configured to:
obtain sensed values measured by heterogeneous sensors mounted in a vehicle;
perform map matching using the HD map constructed in advance and the sensed values; and
determining whether or not the HD map has changed based on a result of the map matching.

22. The vehicle of claim 21, further comprising a satellite-based positioning module mounted therein,
wherein the at least one processor performs the map matching on the HD map using the sensed values based on position values measured by the satellite-based positioning module.

23. The vehicle of claim 22, wherein the at least one processor performs the map matching on the HD map using the sensed values based on the position values for each of the heterogeneous sensors.

24. The vehicle of claim 23, wherein the heterogeneous sensors include a front view image sensor for obtaining a front view image of the vehicle, a surround view monitor (SVM) image sensor for obtaining a surround view image of the vehicle, and a Light Detection and Ranging (LiDAR) sensor for obtaining a point cloud of the vehicle using a laser.

25. The vehicle of claim 24, wherein the at least one processor matches the sensed values measured by the front view image sensor to the HD map based on the position values and performs lane matching by comparing a first lane obtained from the sensed values with a second lane obtained from the HD map.

26. The vehicle of claim 25, wherein the at least one processor matches the sensed values measured by the SVM image sensor to the HD map based on the position values and performs road marker matching by comparing a first road marker obtained from the sensed values with a second road marker obtained from the HD map.

27. The vehicle of claim 26, wherein the at least one processor matches the sensed values measured by the LiDAR sensor to the HD map based on the position values and performs feature matching by comparing a first point obtained from the sensed values with a second point obtained from the HD map.

28. The vehicle of claim 27, wherein the at least one processor determines whether or not lanes on the HD map have changed based on a result of the lane matching, determines whether or not road markers on the HID map have changed based on a result of the road marker matching, and determines whether or not a feature on the HD map has changed based on a result of the feature matching.

29. The vehicle of claim 28, wherein the at least one processor is further configured to update the HD map based on the sensed values in a case where the HD map has changed.
